(19) United States
(12) Patent Application Publication
(10) Pub. No.: US 2017/0239854 A1
(43) Pub. Date: Aug. 24, 2017

(54) Method of manufacturing hexagonal boron nitride laminates

(71) Applicants: Jingyu ZHANG, Chungwu Township (CN); Kuo-Hsin CHANG, Dalin Township (TW); Jia-Cing CHEN, Tainan City (TW); Chung-Ping LAI, Zhubei City (TW)

(72) Inventors: Jingyu ZHANG, Chungwu Township (CN); Kuo-Hsin CHANG, Dalin Township (TW); Jia-Cing CHEN, Tainan City (TW); Chung-Ping LAI, Zhubei City (TW)

(21) Appl. No.: 15/049,019

(22) Filed: Feb. 20, 2016

(51) Int. Cl. B29C 41/24; B05D 3/12

(52) U.S. Cl. CPC B29C 41/24; B05D 3/12; B29K 2105/16

(57) ABSTRACT

A method of manufacturing hexagonal boron nitride laminates contains steps of: a) Dissolving dielectric polymers in solvent. b) Mixing h-BN powder to form a well-mixed h-BN coating slurry. c) Coating slurry on substrates and dried at 100 to 150° C. d-1) For free standing h-BN film, peel off h-BN dielectric polymer layer from substrate in water batch by roll to roll process. d-2) For h-BN film on substrates, heat compression of the substrates and hBN laminates at 100 to 250° C. for multi-layer structures. Thereby, hexagonal boron nitride laminates exhibit thermal conductivity of 10 to 40 W/m·K, which is significantly larger than that currently used in thermal management. In addition, thermal conductivity of hexagonal boron nitride laminates increases with the increasing mass density, which opens a way of fine tuning of its thermal properties.

### FIELD OF THE INVENTION

The present invention relates to a method of manufacturing hexagonal boron nitride laminates which exhibits thermal conductivity of hexagonal boron nitride laminates 10 to 40 W/m·K, which is significantly larger than that currently used in thermal management.

### BACKGROUND OF THE INVENTION

Increasing circuit density and miniaturization of the modem electronics make the highly efficient heat removal and dissipation ever more critical for reliable operation of the electronic devices and systems. Hence the industry is in an urgent need of novel thermally conductive materials suitable for various thermal management applications. It is especially beneficial if such materials are electrically insulating since it would make it possible to apply them directly on the electronic circuitry. Unfortunately, most of the economically viable insulating materials are characterized by low thermal conductivity, which seriously limits their application as efficient heat spreaders.

It has been long known that bulk hexagonal boron nitride (hBN) possess one of the highest basal plane thermal conductivities among other materials (up to 400 W/m·K at room temperature) and almost matches that of silver. The more recent interest in hBN has been motivated by the search of an electrically insulating counterpart of graphene suitable for thermal management applications. Apart from excellent dielectric properties, few atomic layer hBN crystals demonstrated high values of thermal conductivity approaching its bulk value, and ultimately predicted to exceed those. Considering the rare combination of the electrical insulating behaviour with exceptionally high thermal conductivity hexagonal boron nitride is a promising candidate for the next-generation thermal management materials. However to exploit the remarkable properties of the few-layer hBN crystals for practical applications would require thermally conductive layers to be either flexible or conformal with the surface, and to have little heat junction within channel in a preferred orientation. All of those requirements can be satisfied by obtaining laminates consistent of thin (preferable monolayer) hBN crystals. It has been demonstrated before that graphene laminates possess relatively high thermal conductivity (up to 100 W/·K) alongside with perfect coating properties. Unfortunately, the number of potential thermal management applications of such graphene laminates is limited by their high electrical conductivity. On the other hand, hBN laminates are also expected to provide high thermal conductivity in conjunction with excellent electrical insulating properties, which can potentially become a paradigm changer for the electronic industry.

The present invention has arisen to mitigate and/or obviate the afore-described disadvantages.

### SUMMARY OF THE INVENTION

The primary objective of the present invention is to provide a method of manufacturing hexagonal boron nitride laminates which exhibits thermal conductivity of hexagonal boron nitride laminates 10 to 40 W/m·K

Another objective of the present invention is to provide a method of manufacturing hexagonal boron nitride laminates in which a thermal conductivity of hexagonal boron nitride laminates increase with the increasing mass density, which opens a way of fine tuning of its thermal properties.

To obtain above-mentioned objective, a method of manufacturing hexagonal boron nitride laminates provided by the present invention contains steps of:

a) Dissolving 10 to80 wt % dielectric polymers in solvent.

b) Mixing 20 to 90 wt % h-BN powder to form a well-mixed h-BN coating slurry.

c) Coating slurry on substrates and dried at 100 to 150° C. A layer of h-BN laminates was obtained after this process.

d-1) For free standing h-BN film, peel off h-BN dielectric polymer layer from substrate in water batch by roll to roll process.

d-2) For h-BN film on substrates, heat compression of the substrates and hBN laminates at 100 to 250° C. for multi-layer structures.

### BRIEF DESCRIPTION OF THE DRAWINGS

FIG. 1(A) is a SEM micrograph of the surface of the hBN laminate, wherein vertical variations of contrast are due to the charging, and scale bar is 1 μm.

FIG. 1(B) is a cross-sectional SEM image of hBN laminate, wherein scale bar is 10 μm.

FIG. 2 shows thermal conductivity κ as a function of temperature T measured for different values of hBN laminates density ρ.

FIG. 3 shows thermal conductivity κ of hBN laminates as a function of density measured at 80° C. (blue circles), wherein solid curves represent results of numerical simulations at different values of the thermal contact conductance.

FIG. 4 is a schematic view illustrating the laminate model used in numerical simulations for low (A) and high (B) density samples, wherein an individual hBN flake is modeled by a solid block with lateral dimensions 1 μm×1 μm and thickness 10 nm.

### DETAILED DESCRIPTION OF THE PREFERRED EMBODIMENTS

A method of manufacturing hexagonal boron nitride laminates according to a preferred embodiment of the present invention contains steps of:

a) Dissolving 10 to 80 wt % dielectric polymers in solvent.

Preferably, the dielectric polymer is at-least one of the following polymers, including polyethylene terephthalate (PETP), polyphenylene sulfide (PPS), polyetherimide (PEI), polyetherether ketone (PEEK), polyetherketone (PEK), polyimide (PI), Polyvinylidene fluoride (PVDF), phenol resin or acrylic resins.

b) Mixing 20 to 90 wt % h-BN powder to form a well-mixed h-BN coating slurry.

Preferably, the thickness of h-BN powders ranges from 1 to 500 nm, and the size is from 0.1 to 100 μm.

c) Coating slurry on substrates and dried at 100 to 150° C. A layer of h-BN laminates was obtained after this process.

d-1) For free standing h-BN film, peel off h-BN dielectric polymer layer from substrate in water batch by roll to roll process.

d-2) For h-BN film on substrates, heat compression of the substrates and hBN laminates at 100 to 250° C. for multi-layer structures.

Preferably, the substrates are electrically conductive layers such as Cu or Al foils.

Preferably, the thickness of one conductive layer ranges from 10 um to 100 um.

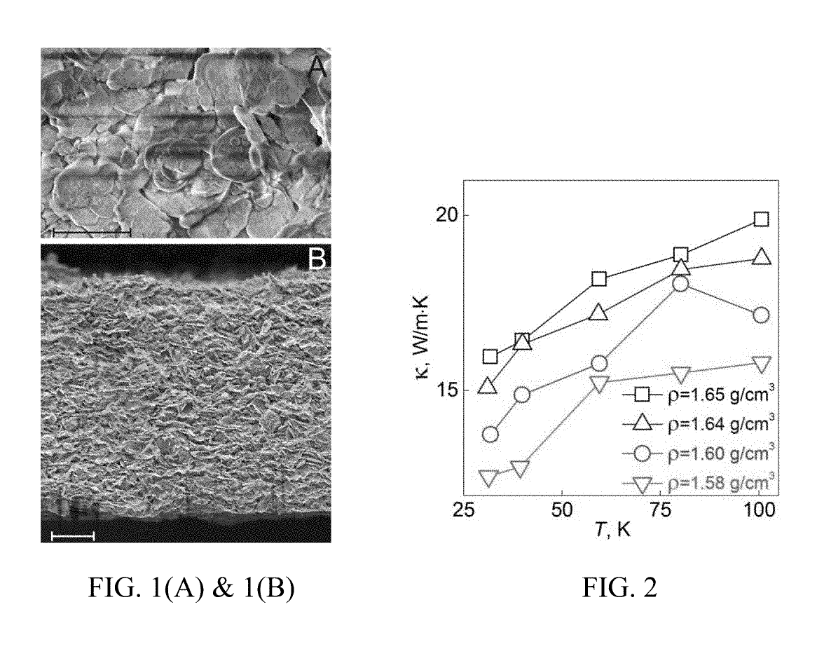

As shown in FIG. 1, analysis of the top and cross-sectional SEM images of the laminate film reviles the dominant lateral dimensions of hBN laminate film are around 1 μm with average thickness of about 10 nm. The SEM figures also reveal how hBN powders construct heat dissipation channels to exhibit its high thermal conductivity. FIG. 1A shows the lateral contacts between hBN powders, while FIG. 1B illustrates an amorphous stacking of hBN powders in cross sectional view, which ensures the heat could be dissipated to all directions.

The thermal conductivity κ of the investigated laminates has been calculated using equation

κ=αρCₚ, (1)

here α is the in-plane thermal diffusivity, ρ is the material density and Cₚ is the specific heat. All three parameters were independently determined in experiment.

The thermal diffusivity α as a function of temperature T has been measured by the laser flash method using commercially available system (Netzsch LFA 457). To measure the in-plane thermal diffusivity the special sample holder has been used, which accommodates the free-standing hBN membrane samples cut into a round shape of 22 mm in diameter. A small spot of about 5 mm in diameter at the back side of the sample is flash heated by the laser beam. The heat diffusion as a function of time is registered by the infrared detector along the top circumference of the membrane at 5 mm to 6 mm from the centre of the sample. To avoid undesirable reflections the sample and sample holder have been spray coated with graphite paint. During the measurements the sample chamber of the laser flash system was continuously purged with nitrogen gas at the rate of 30 ml/min. The sample specific heat Cₚ was measured by the differential scanning calorimeter (Netzsch DSC 404 F3) using sapphire as a reference sample. The mass density p was estimated by weighting the sample of the known dimensions with precision electronic balances.

To evaluate the effect of the membrane composition we measured the thermal conductivity κ as a function of temperature T for four hBN laminates with different mass density. As seen from FIG. 2, the thermal conductivity is weakly dependent on temperature and increases with the increasing density. The observed values of the thermal conductivity fall in the range between 10 W/m·K to 20 W/m·K, which is certainly an industrially relevant value.

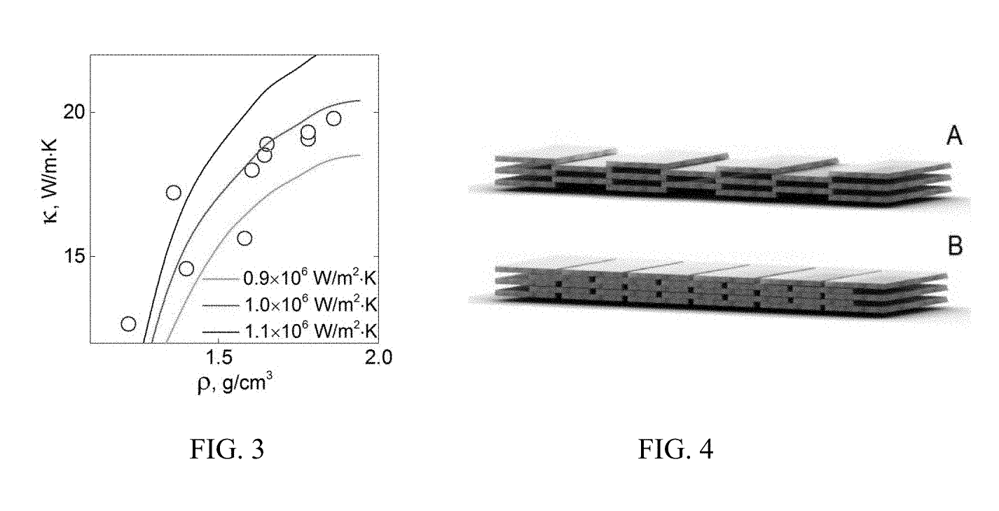

To better understand the influence of the material density on the thermal conductivity we studied the dependence of κ on ρ at room temperature. The density of the laminate samples was controlled in two different ways: (i) by using hBN flakes of different thickness (only limited variations of p could be achieved in this way), and (ii) by variation of the additional roller compression applied during preparation of the laminates. Both methods had the same effect on the thermal conductivity. The combined results of this study are presented in FIG. 3. Similarly to the data shown in FIG. 2 the thermal conductivity tends to increase with the increasing density of the hBN laminate.

After systematic SEM examination of the laminates of different density, we concluded that the density variations are mostly due to the variation in the size of empty voids present between stacked hBN flakes. The schematic representation of two laminates with different density is given in FIG. 4. Thus we attribute the decreasing thermal conductivity to the discontinuity in the thermal path brought by the larger number of voids.

To confirm our suggestions, we carried out modeling of the thermal flow in laminates with voids. Our numerical simulation was done using ABAQUS 2011 finite element analysis software package. In order to explore the relation between the effective thermal conductivity and the density of hBN laminates we simulated the steady-state heat transfer governed by equation

$$ρ {C}_{p} \frac{\partial T}{\partial t} = \frac{\partial }{\partial x} ( κ ( T ) \frac{\partial T}{\partial x} ) + \frac{\partial }{\partial y} ( κ ( T ) \frac{\partial T}{\partial y} ) + \frac{\partial }{\partial z} ( κ ( T ) \frac{\partial T}{\partial z} ) + Q , \qquad ( 2 )$$

where Q is the heat flux and ∂T/∂t=0 (steady-state heat transfer). The modeled system was evaluated with the ABAQUS element type DC2D8 and represented by a strip of orderly stacked solid blocks of thermally conductive media with lateral size of 1 μm×1 μm and thickness of 10 nm, as show in FIG. 4. To mimic the hBN flakes the thermal conductivity of the solid blocks was chosen to be 390 W/m·K at room temperature. To vary the effective density of the modeled laminates, we adjusted the overlap area of the adjacent blocks as illustrated in FIGS. 4(A) and 4(B). Also, to account for the imperfect thermal contact between the stacked flakes the finite thermal contact conductance has been introduced to the model. The final modeling results were matched to the experimental data by variation of the thermal contact conductance in the range of 10⁵ W/m²K to 10⁶ W/m²K. The resulting effective thermal conductivity κ_{eff} of the hBN laminate was calculated using the Fourier law

$${κ}_{eff} = q \frac{L}{Δ T} . \qquad ( 3 )$$

Here q is the total net heat flux through the cross section of the laminate, L is the total length of the laminate strip and ΔT is the temperature difference between hot and cold ends of the strip.

The result of the numerical simulation is shown by solid curves in FIG. 3. Each of the curves represents the effective thermal conductivity of the laminate with different thermal contact resistance between the stacked hBN flakes. The simulation shows only qualitative agreement with the experimental data because of simplicity of our model. A more accurate simulation would have to take into account size distribution of the flakes as well as the dependence of the contact conductance on the packing density. Nevertheless, our initial assumption that the thermal conductivity is restricted by the presence of the empty voids inside the laminate has been confirmed by this simple model. Also, it gave us a rough estimate of the thermal contact conductance to be of the order of 10⁶ W/m²·K. There is no data on the thermal contact conductance is available for such a system, however experimental study of a rather similar graphene/hBN interface reviles the value of around 7·10⁶ W/m²·K, which is almost an order of magnitude higher than estimated in our simulation. The most probable explanation to this is the fact that the hBN flake surfaces are contaminated with solvent residues, which in turn reduces thermal conductivity across the flake-to-flake interface.

In conclusion, we demonstrated that hBN inks can be used to produce laminates with thermal conductivity as high as 20 W/m·K in the above mentioned embodiment, which is significantly larger than that for materials currently used in thermal management. We also show that the effective thermal conductivity can be adjusted by varying the laminate packing density. We also identify a potential way for further increase in of thermal conductance by improving the quality of the flake-to-flake interface. Being electrically insulating, hBN laminates can potentially open a new avenue for using the advanced thermal management materials.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A method of manufacturing a hexagonal boron nitride laminates according to a preferred embodiment of the present invention contains steps of:
a) Dissolving 30 to 80 wt % dielectric polymers in solvent;
b) Mixing 20 to 70 wt % h-BN powders to form a well-mixed h-BN coating slurry; and
c) Coating slurry on a substrates and dried at 100 to 150° C., a h-BN laminates was obtained after this process.

2. The method of manufacturing the hexagonal boron nitride laminates as claimed in claim 1, wherein the dielectric polymer is flexible after curing with thickness of film ranging from 5 um to 200 um, and the dielectric polymer is selected from at-least one of the following polymers, including the groups comprising polyethylene terephthalate (PETP), polyphenylene sulfide (PPS), polyetherimide (PEI), polyetherether ketone (PEEK), polyetherketone (PEK), polyimide (PI), Polyvinylidene fluoride (PVDF), phenol resines and acrylic resins.

3. The method of manufacturing the hexagonal boron nitride laminates as claimed in claim 1, wherein each of the h-BN powders is a flake powder with a 2-D layer structure, a diameter of each h-BN powders ranges from 0.34 to 500 nm, and the size is from 0.1 to 100 μm.

4. The method of manufacturing the hexagonal boron nitride laminates as claimed in claim 1, wherein the substrate is electrically conductive layers such as Cu or Al foils.

5. The conductive layer in claim 4 is further etched or processed to form an electric circuit.

6. The conductive layer in claim 4 is thoroughly etched or detached to attain a free-standing laminate.

7. The conductive layer in claim 4, wherein the thickness of the conductive layer ranges from 10 um to 100 um.
